(19) United States
(12) Patent Application Publication
(10) Pub. No.: US 2025/0219751 A1
(43) Pub. Date: Jul. 3, 2025

(54) RATELESS CODING AND FEEDBACK SCHEME FOR COMMUNICATION SYSTEMS

(71) Applicant: Intel Corporation, Santa Clara, CA (US)

(72) Inventors: Barath C. Petit, Bangalore (IN); Chandrashekar Devegowda, Bangalore (IN); Sheetal Bhasin, Bangalore (IN); Amit Singh Chandel, Bangalore (IN); Naveen Manohar, Bangalore (IN); Ashwini Rathi, Tikri (IN); Jayprakash Thakur, Bangalore (IN); Suranjan Chakraborty, Bangalore (IN)

(21) Appl. No.: 18/397,162

(22) Filed: Dec. 27, 2023

(51) Int. Cl. H04H 20/42; H04H 60/32; H04H 60/92

(52) U.S. Cl. CPC H04H 20/423; H04H 60/32; H04H 60/92

(57) ABSTRACT

A device can include memory to store source packets and coded packets. The device can include processing circuitry to perform a first coding phase and a second coding phase. In the first coding phase, the processing circuitry can combine the source packets to generate a first set of coded packets, where a coded packet can be defined according to a degree, the degree being a count of the source packets used to generate the coded packet. In the second coding phase, the same source packets into a second set of coded packets, such that a total number of coded packets generated in the first encoding phase and in the second encoding phase is greater than a total number of source packets. In another aspects, broadcasters can receive feedback beacons and modify broadcast accordingly.

### TECHNICAL FIELD

Aspects of the disclosure pertain to communication systems. More particularly, aspects relate to improving reliability and providing feedback in communication systems.

### BACKGROUND

Reliability is important in electronic communications. Some methods for improving reliability involve retransmitting data, but retransmission can take up large amounts of bandwidth. Transmitters or data sources may also need user or user device feedback to make reliability decisions and power transmission decisions.

### BRIEF DESCRIPTION OF THE DRAWINGS

In the drawings, which are not necessarily drawn to scale, like numerals may describe similar components in different views. Like numerals having different letter suffixes may represent different instances of similar components. Some aspects are illustrated by way of example, and not limitation, in the figures of the accompanying drawings in which:

FIG. 1 illustrates a network in which some methods can be implemented according to aspects of the disclosure.

FIG. 2 illustrates an example of rateless coding.

FIG. 3 is an illustrative example of rateless codes according to aspects of the disclosure.

FIG. 4 illustrates a method for rateless coding according to some aspects of the disclosure.

FIG. 5 illustrates broadcast feedback beacons according to some aspects of the disclosure.

FIG. 6 illustrates a block diagram of a communication device such as an evolved Node-B (eNB), a new generation Node-B (gNB), an access point (AP), a wireless station (STA), a mobile station (MS), or a user equipment (UE), in accordance with some aspects.

FIG. 7 illustrates a system level diagram, depicting an example of an electronic device (e.g., system) that can include, for example, a transmitter configured to selectively fan out a signal to one of multiple communication channels.

### DETAILED DESCRIPTION

The following description and the drawings sufficiently illustrate specific aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

Some communication systems rely on duplicate transmission of the packets to overcome the difficulty of feedback from all the broadcast receivers (also known as an “ACK implosion problem”), which can lead to bandwidth, coexistence, and power issues, among other problems.

Some communication systems also lack a mechanism to receive user feedback. These communication systems therefore cannot accurately gauge network quality.

### Rateless Coding Scheme

Bluetooth Low Energy Audio (LE Audio) can improve user audio experience through use of features such as audio sharing, spatial audio, hearing aids, etc. with improvements to power, latency and other performance indicators compared to classic audio. Broadcast capability can enable these and other use cases and features, and can find usage in educational environments, entertainment, and other scenarios and industries.

As mentioned earlier herein, Bluetooth broadcast systems employ a naïve re-transmission scheme, which results in sub-optimal bandwidth usage and incurs high airtime and duty-cycle overhead. To address these and other challenges, methods, and systems according to aspects of this disclosure provide a two phase rateless coding solution proposed to avoid retransmissions and resulting in bandwidth and air-time savings.

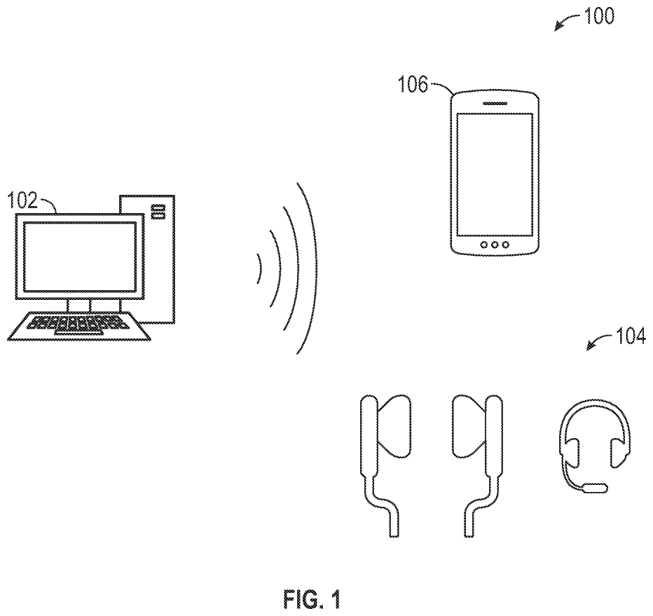

FIG. 1 illustrates a network 100 in which some methods can be implemented according to aspects of the disclosure. The network can include one or more source device/s 102. The source device can be a broadcaster and source of a data stream. While a PC or computer-like device 102 is shown, other devices can include smart phones, tablets, computer terminals, etc. Receiver/s 104 can include Bluetooth headset/earbuds consuming the broadcast stream. An assistant, or broadcast assistant 106 can help the receiver 104 in scanning for and joining the stream of choice. This can include smartphone which is connected to the BT headsets 104 thereby presenting an interface for a user to choose the broadcast stream of choice.

Bluetooth broadcast streams (as with any broadcast stream) suffers from a typical ACK implosion problem whereby scalable per-packet feedback from all receivers is not feasible. This can be addressed by duplicating transmission of each packet a given number of times (for example an immediate repetition count (IRC)). However, this naïve scheme leads to a bandwidth overhead and airtime expenditure.

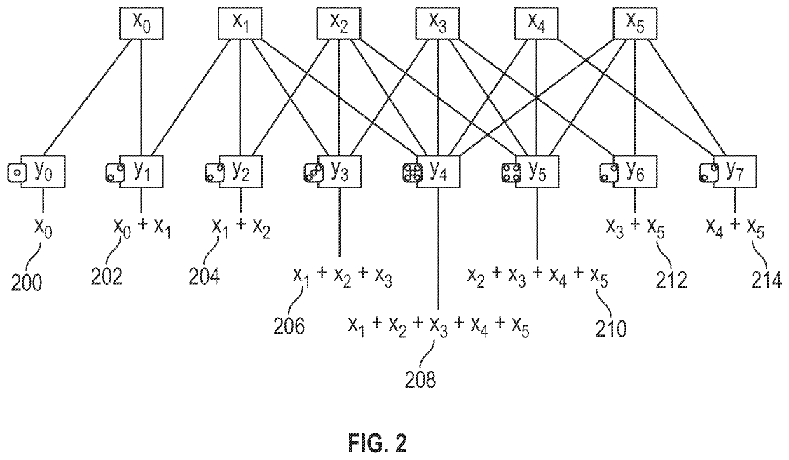

The proposed solution entails coding the broadcast source packets via rateless codes using a two-phase coding procedure. The concept of rateless coding is illustrated in FIG. 2.

FIG. 2 illustrates an example of rateless coding. In the example, six original symbols {x₀ . . . x₅} can be decoded by a receiver on reception of any six of the eight coded symbols {y₀ . . . y₇} in any order. The eight coded symbols {y₀ . . . y₇} represent equations 200, 202, 204, 206, 208, 210, 212 and 214. For example, Equation 200 is y₀=x₀; Equation 202 is y1=x₀+x₁; Equation 202 is y₂=x₁+x2; Equation 3 is y₃=x₁+x₂+x₃, etc. as shown in FIG. 2. The illustrated equations are examples only, and furthermore serve for purposes of illustrating rateless coding only. Eight equations with six unknowns ({x₀ . . . x₅}) are generated, and the receiver can determine the six unknowns from the six equations. If any six of the eight equations are received, the unknowns can be determined regardless of the order of the coded packets received.

Therefore, using rateless coding, if original n packets are coded to m packets (e.g., four packets are coded to six packets, or six packets coded to eight packets as shown in FIG. 2, or any other example numbers where n<m) then in order to decode the original n packets, it is sufficient for the receiver to receive at least any n of the m coded packets (in any order) as long as the certain conditions are met during coding as discussed below. For example, two-phase coding as discussed below can be used.

The rateless coding approach affords significant bandwidth and airtime savings even when compared against the minimum broadcast repetition count of two as illustrated below, e.g., if four packets are coded to six packets, then only six packets need to be transmitted instead of eight. By reducing the number of packets transmitted, while still allowing for receivers to receive packets in a variety of suboptimal network conditions/transmission conditions, the broadcast source can save transmission overhead for additional airtime or other traffic, and/or latency can be reduced by the need for fewer broadcast transmissions, and/or power can be reduced by requiring fewer transmissions from the source. Power savings can be achieved at receivers because receivers only need to be awake to receive a smaller number of coded packets under the rateless coding algorithms of example aspects of this disclosure.

A two-phase rateless coding algorithm for broadcast according to example aspects includes first defining a tuple parameter (n, m) signifying a block of n source packets being mapped to m coded packets as per the algorithm described later herein, where n<=m<2n.

For purposes of description of example aspects of the disclosure, the degree d of each coded packet is the number of source packets used to generate the coded packet. In example aspects, the coded packet can be generated by XORing the chosen d source packets, although the XOR operation can be replaced by any invertible operation in the algorithm.

In phase one of two-phase coding, the first n coded packets shall be generated. To ensure that any receiver correctly receiving the first n coded packets can decode the original n source packets, the coding sequence is presented/defined in phase one such that all the original n source packets are covered in the coded packets.

Pseudocode for phase one is provided in Table 1:

TABLE 1
Phase One Pseudocode.

```
Mark all elements of X as unmarked
For i = 1 to n:
  Sample degree dᵢ from P₁(d)
  GEN DEG:
  D={ }
  If no unmarked elements in X:
    Pick uniformly d1 elements and assign to D
  Else:
    Prioritize unmarked elements and assign to D
  If D is not unique with respect to previous iterations:
    goto GEN_DEG
  Set the selected elements of X as marked
yᵢ = 0
∀ s ∈ D, yᵢ = yᵢ ⊕ s
```

In Table 1, X is the set of n source packets: X={x₁, x₂, . . . , xₙ}. Y is the set of m coded packets: Y={y₁, y₂, . . . , yₘ} and wherein the degree d of each coded packet is the number of source packets coded by that respective coded packet y. The degree can be restricted to two or three or can be sampled from a probability distribution P, which is skewed towards lower degree values for the first phase. P₁(d) is the phase one degree probability mass function (P₂(d)) is used in phase two described later herein and signifies phase two-degree probability mass function). Lower degree is preferred or specified in the first phase to ensure maximum diversity in the coded packets in the first phase with respect to the original constituent source packets.

In phase two of two-phase coding, he remaining coded packets (n+1, m) are generated. The degree d shall be maximized so that a maximum number of missing constituent source packets (due to packet loss in phase one) can be recovered in phase two. The degree can be sampled from a probability distribution which is skewed towards higher degree values.

Pseudocode for phase two is provided in Table 2:

TABLE 2
Phase Two Pseudocode.

```
For i = n+1 to m:
  Sample degree dᵢ from P₂(d)
  GEN DEG:
  D={ }
  Pick uniformly dᵢ elements and assign to D
  If D is not unique with respect to previous iterations:
    goto GEN_DEG
  Set the selected elements of X as marked
yᵢ = 0
∀ s ∈ D, yᵢ = yᵢ ⊕ s
```

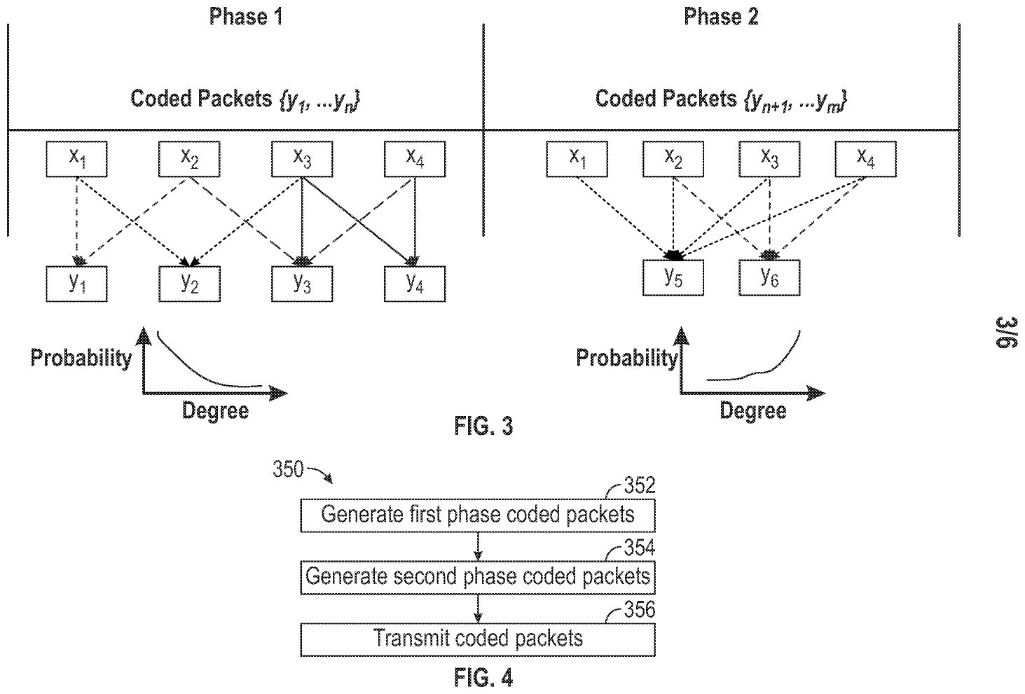

FIG. 3 is an illustrative example of rateless codes according to aspects of the disclosure. In the example, (n, m)=(4, 6), meaning that four source packets (X={x₁, x₂, x₃, x4}) are mapped to six coded packets (Y={y₁, y₂, y₃, y₄, y₅, y₆}). In phase one, all source packets xᵢ are covered by at least one of the coded packets yᵢ so that the receiver can immediately decode and solve for all xᵢ if all n packets are received in phase one. In phase one, the degree of each coded packet yᵢ is minimized, meaning the probability of choosing a high degree is lower. In phase two, the degree of each coded packet yᵢ is maximized, meaning the probability of choosing a high degree is higher to enable the receiver to account for all source packets xᵢ if any of them are lost in phase one.

The probability mass functions (PMF) to be chosen for the phases 1 and 2: P₁(d) and P₂(d) have different characteristics. For example, with phase one PMF P₁(d), higher weightage given to low degree values. On the other hand, phase two PMF P₂(d) gives higher weightage to higher degree values.

Some example PMFs for each phase are shown in Table 3:

TABLE 3
example PMF types to be used for each of phase one and phase two.

| P₁(d) | P₂(d) |
|---|---|
| Geometric distribution | Negative Hypergeometric* |
| Negative Binomial * | Weighted PMF with pre- |
| Negative Hypergeometric * | assigned weights for higher |
| Weighted PMF with pre-assigned | degrees e.g., if n = 4 then |
| weights for lower degrees e.g., | p(3) = 1/3, p(4) = 2/3 |
| p(2) = 2/3, p(3) = 1/3 | |
| Ideal Soliton: | |
| $p ( 1 ) = \frac{1}{K} ,$ | |
| $p ( i ) = \frac{1}{i ( i - 1 )} ( i = 2 , 3 , … , K ) .$ | |

* With appropriate shape parameter

A presentation delay is an additional delay defined by LE Audio specification until the samples are rendered at a receiver so that rendering can be synchronized across all receivers. This delay can be leveraged by above proposed two-phase rateless coding algorithm. For example the values of (n.m) can be chosen aggressively based on value of the presentation delay.

FIG. 4 illustrates a method 350 for rateless coding according to some aspects of the disclosure. The method 350 can be done by a broadcast source (e.g., source 102) or component thereof (e.g., processing circuitry). The method 350 can begin with in a first encoding phase according to operation 352. Operation 352 can include the source 102 combining the source packets to generate a first set of coded packets. As defined earlier herein, a coded packet being defined according to a degree, the degree being the number of source packets used to generate the coded packet. The first phase can be implemented according to Table 1.

The method 350 can continue with phase two encoding according to operation 354 with the source 102 (or processing circuitry therein) combining the source packets into a second set of coded packets, such that a total number of coded packets generated in the first encoding phase and in the second encoding phase is greater than a total number of source packets. Second phase encoding can be implemented according to Table 2. In operation 356, the source 102 transmits the encoded packets.

Optimized Bluetooth broadcast performance can enhance user experience in sectors such as retail, personal audio sharing, education, public announcements, etc. Aspects of this disclosure provide a rateless coding scheme for Bluetooth LE Audio Broadcast. The scheme can avoid re-transmissions and reduce the amount of data that needs to be transmitted, which improves the PC/peripheral battery life and reduces latency. The scheme also boosts the robustness of the audio stream to errors, making broadcast schemes more suitable for use in noisy environments. Solutions can be integrated without changes to Bluetooth standards.

### Scalable Receiver Feedback Scheme

As mentioned earlier herein, Bluetooth broadcast sources (and other broadcast networks) lack a reliable feedback scheme. This forces broadcast sources to transmit with sub-optimal stream parameters. Bluetooth broadcast (and broadcast in general) can suffer from an ACK implosion problem whereby scalable per-packet feedback from all the receivers is not feasible.

As is the norm in a typical broadcast network, the Bluetooth broadcast source has no feedback to go by for deciding an optimal value for the repetition count. Since there is no feedback from receivers, the source lacks knowledge of the real-time broadcast network parameters, for example channel quality, number of active receivers, etc.

To address these and other concerns, methods in accordance with some aspects can provide a scalable feedback scheme for Bluetooth broadcast systems that can leverage Bluetooth broadcast topology based on a beacon methodology. The beacon method can be done without changes to hardware or software in Bluetooth earbuds, headsets, etc.

The broadcast source can dynamically tune the transmission parameters based on real-time feedback provided in systems according to aspects of the disclosure. The source can set parameters to change the transmission repetition count based on receiver channel quality and reception. The source can modulate the transmission power based on the estimated farthest receiver. The source can monitor the number of active receivers and take appropriate action e.g., reduce or increase meta-data advertising frequency. For example, broadcasting can be turned off if the number falls to zero. Any of the aspects described herein can be used for other broadcasting types, e.g., Wi-Fi (wherein the Bluetooth advertising beacons can be replaced by Wi-Fi beacons).

Reference turns again to FIG. 1. Typically, broadcast channels and networks do not implement a feedback channel for the receivers due to the aforementioned ACK implosion problem. However, the unique architecture shown in FIG. 1 provides the broadcast assistant 106 that can mediate between the source 102 and receiver 104 to provide a reliable and scalable feedback scheme.

Because the broadcast assistant 106 is often a smartphone or similar device, the broadcast assistant 106 will typically include a user interface and can provide features such as Bluetooth advertising application programming interfaces (APIs) for providing this advertising. Further, the broadcast assistant 106 is typically collocated with the receiver 104 and is typically connected to the receiver 104 most or all of the time that the receiver 104 is being used. Accordingly, the broadcast assistant 106 should have knowledge of the Bluetooth channel quality of the receiver 104. Further, as specified in some broadcast specifications, the receiver 104 shall notify the broadcast assistant 106 on joining and exiting the stream and accordingly user counts and other tracking should be relatively straightforward.

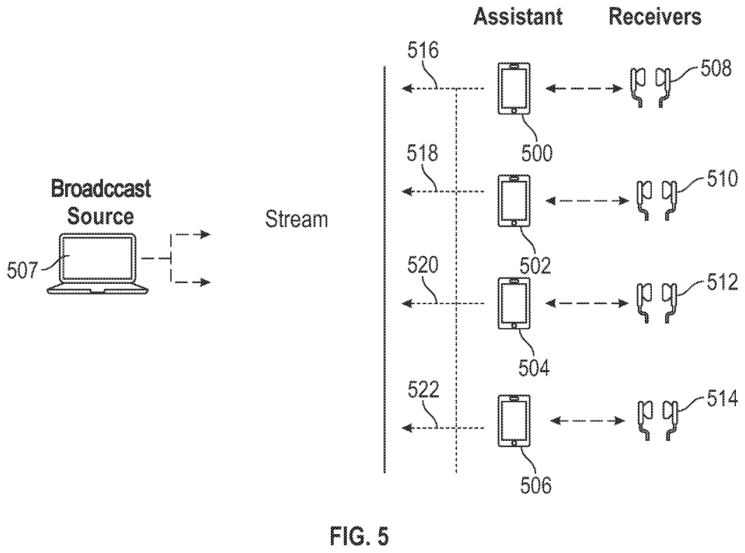

Solutions according to aspects of the present disclosure are illustrated in FIG. 5. A broadcast assistant 500, 502, 504, 506 can share periodic feedback to the source 507. As mentioned earlier herein, the broadcast assistant 500, 502, 504, 506 can exploit co-location with and notifications from the receiver 508, 510, 512, 514 to send periodic updates to source 507 via respective Bluetooth Advertisement beacons 516, 518, 520, 522. Some updates can include a receiver 508, 510, 512, 514 joining the Bluetooth broadcast stream, providing a periodic receiver BT channel link quality update, or exiting the Bluetooth broadcast stream.

While four receivers and broadcast assistants are shown, any number, including dozens, hundreds, or thousands, of receivers and broadcast assistants may be receiving broadcasts from source 507. Further, there may be multiple sources in a system broadcast same or different streams. Beacons can be encrypted. A broadcast code can be shared between the source 507 and receivers 508, 510, 512, 514 for the media packets. The same code can be used to encrypt and decrypt the advertisement beacons from the broadcast assistants 500, 502, 504, 506 and the source 507 thereby ensuring security and authentication.

Broadcast assistants 500, 502, 504, 506 can connect via headset to receiver/s 508, 510, 512, 514. The broadcast assistants 500, 502, 504, 506 can scan for signals on behalf of the receiver/s 508, 510, 512, 514 and provide a UI interface for a receiver/s 508, 510, 512, 514 to select a desired stream, source, or other options. Subsequent to the selection, the broadcast assistants 500, 502, 504, 506 can provide bootstrap information to the receiver/s 508, 510, 512, 514 after which the receiver 508, 510, 512, 514 can join a stream. The receiver 508 510, 512, 514 can notify the assistant 500, 502, 504, 506 on joining and exiting the stream by writing to a broadcast receive state characteristic. Asynchronous connection-oriented logical transport (ACL) can be leveraged as well for communications of different statuses, etc.

Bluetooth source 507 hardware can provide an exclusive interface for Bluetooth LE scanning of Advertisements thus enabling concurrent operation of BT scanning and broadcast streaming. Any type of source 507 device can implement proposed protocols without changes to Bluetooth broadcasting specifications.

Regarding the management of Advertisement transmission schedule from the various receivers 508, 510, 512, 514, a staggered or interleave scheme can be deployed to ease the seamless scanning of the same from the source 507, For example, broadcast assistants 500, 502, 504, 506 can transmit advertisements after choosing a random backoff interval each time. Alternatively, the Bluetooth Periodic Advertising feature can be used with each broadcast assistant 500, 502, 504, 506 assigned a periodic advertising interval which can be staggered or interleaved with respect to the other receivers 508, 510, 512, 514 or broadcast assistants 500, 502, 504, 506. In this case, the timing can be assigned by the source 507 and conveyed over Bluetooth advertisements from the source 507. Bluetooth advertising intervals can range from 20 msecs to 10.24 seconds with 0.625 msec increments. Thus, a suitably designed schedule can accommodate hundreds to thousands of receivers and broadcast assistants.

In one example of source 507 use of feedback, if a threshold number (e.g., 20%) of receivers 508, 510, 512, 514 are reporting bad link quality, then packet repetition count can be increased. Conversely, if a threshold number (e.g., 80%) of receivers 508, 510, 512, 514 are reporting high link quality, then packet repetition count can be decreased. Broadcast assistants 500, 502, 504, 506 can send digests as advertising beacons containing for example unique indexes, BT RSSI/channel estimate, or reports of asynchronous events such as for example a paired receiver 508, 510, 512 514 switching to a different stream. The source 507 can save power by stopping broadcasts if there are no listeners. Stream power (e.g., transmit power or tx power) can be modified or modulated if receiver/s 508, 510, 512, 514 are far away and power can be reduced if receivers 508, 510, 512, 514 are close.

Little's Law of queuing theory can be used to estimate average number of receivers 508,510, 512, 514 in a broadcast stream based on beacons generated according to aspects of the present disclosure. For example, the stream can be abstracted as an infinite server queue. The estimated average broadcast occupancy can be used by the source 507 as an additional input for tuning the broadcast stream parameters.

Aspects of this disclosure provide a scalable and reliable receiver feedback scheme for Bluetooth LE Audio Broadcast. A feedback protocol, leveraging the unique Broadcast assistant-based topology as described with respect to FIG. 1, enables a broadcast source to dynamically tune the transmission parameters in an optimal manner based on real-time feedback of example aspects of this disclosure. A broadcast source can set parameters for efficient broadcast by for example, changing the transmission repetition count based on receivers' BT channel quality and reception; modulating the transmission power based on estimated farthest receiver; and monitoring the number of active receivers and take appropriate action such as reducing or increasing broadcast meta-data advertising frequency. The feedback protocol of example aspects can be deployed and extended to other broadcast networks e.g., Wi-Fi (the Bluetooth advertising beacons can be replaced by Wi-Fi beacons).

### Other Systems and Apparatuses

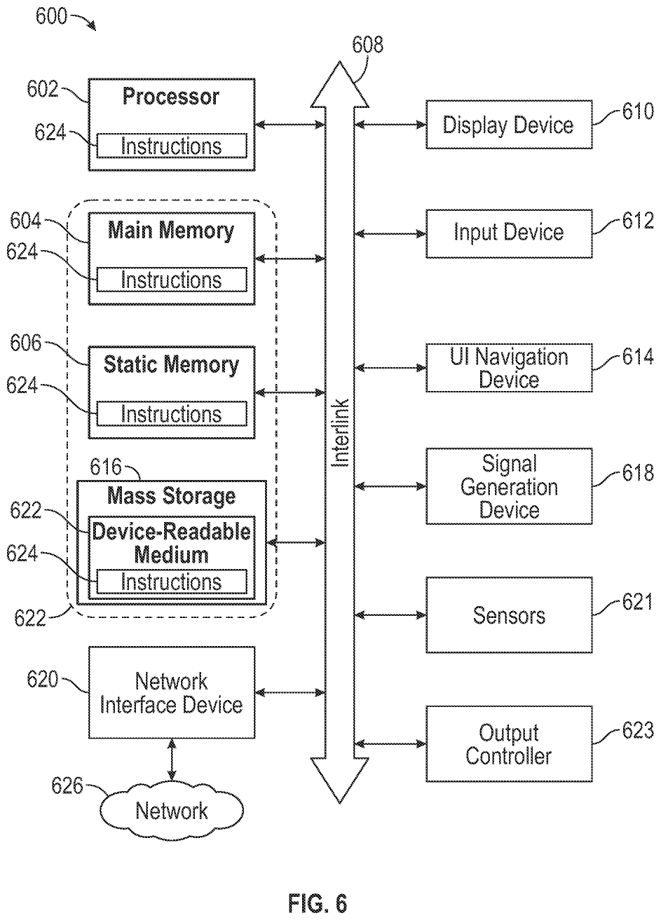

FIG. 6 illustrates a block diagram of a communication device 600 in accordance with some aspects. In alternative aspects, the communication device 600 may operate as a standalone device or may be connected (e.g., networked) to other communication devices. In some aspects, the communication device 600 can use one or more of the techniques and circuits discussed herein, in connection with any of FIG. 1-FIG. 5.

Circuitry (e.g., processing circuitry) is a collection of circuits implemented in tangible entities of the device 600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 600 follow.

In some aspects, the device 600 may operate as a standalone device or may be connected (e.g., networked) to other devices. In a networked deployment, the communication device 600 may operate in the capacity of a server communication device, a client communication device, or both in server-client network environments. In an example, the communication device 600 may act as a peer communication device in peer-to-peer (P2P) (or other distributed) network environment. The communication device 600 may be a UE, eNB, PC, a tablet PC, a STB, a PDA, a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device (e.g., UE) 600 may include a hardware processor 602 (e.g., a central processing unit (CPU), a graphics processing unit (GPU), a hardware processor core, or any combination thereof), a main memory 604, a static memory 606, and mass storage 616 (e.g., hard drive, tape drive, flash storage, or other block or storage devices), some or all of which may communicate with each other via an interlink (e.g., bus) 608.

The communication device 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The communication device 600 may additionally include a signal generation device 618 (e.g., a speaker), a network interface device 620, and one or more sensors 621, such as a global positioning system (GPS) sensor, compass, accelerometer, or other sensor. The communication device 600 may include an output controller 623, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage 616 may include a communication device-readable medium 622, on which is stored one or more sets of data structures or instructions 624 (e.g., software) embodying or utilized by any one or more of the techniques or functions described herein. In some aspects, registers of the processor 602, the main memory 604, the static memory 606, and/or the mass storage 616 may be, or include (completely or at least partially), the device-readable medium 622, on which is stored the one or more sets of data structures or instructions 624, embodying or utilized by any one or more of the techniques or functions described herein. In an example, one or any combination of the hardware processor 602, the main memory 604, the static memory 606, or the mass storage 616 may constitute the device-readable medium 622.

As used herein, the term “device-readable medium” is interchangeable with “computer-readable medium” or “machine-readable medium.” While the communication device-readable medium 622 is illustrated as a single medium, the term “communication device-readable medium” may include a single medium or multiple media (e.g., a centralized or distributed database, and/or associated caches and servers) configured to store the one or more instructions 624.

The term “communication device-readable medium” may include any medium that is capable of storing, encoding, or carrying instructions for execution by the communication device 600 and that cause the communication device 600 to perform any one or more of the techniques of the present disclosure, or that is capable of storing, encoding or carrying data structures used by or associated with such instructions. Non-limiting communication device-readable medium examples may include solid-state memories, and optical and magnetic media. Specific examples of communication device-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media or machine-readable medium/media). In some examples, communication device-readable media may include communication device-readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), MIMO, or multiple-input single-output (MISO) techniques. In some examples, the network interface device 620 may wirelessly communicate using Multiple User MIMO techniques.

The term “transmission medium” shall be taken to include any intangible medium that is capable of storing, encoding, or carrying instructions for execution by the communication device 600, and includes digital or analog communications signals or other intangible medium to facilitate communication of such software. In this regard, a transmission medium in the context of this disclosure is a device-readable medium.

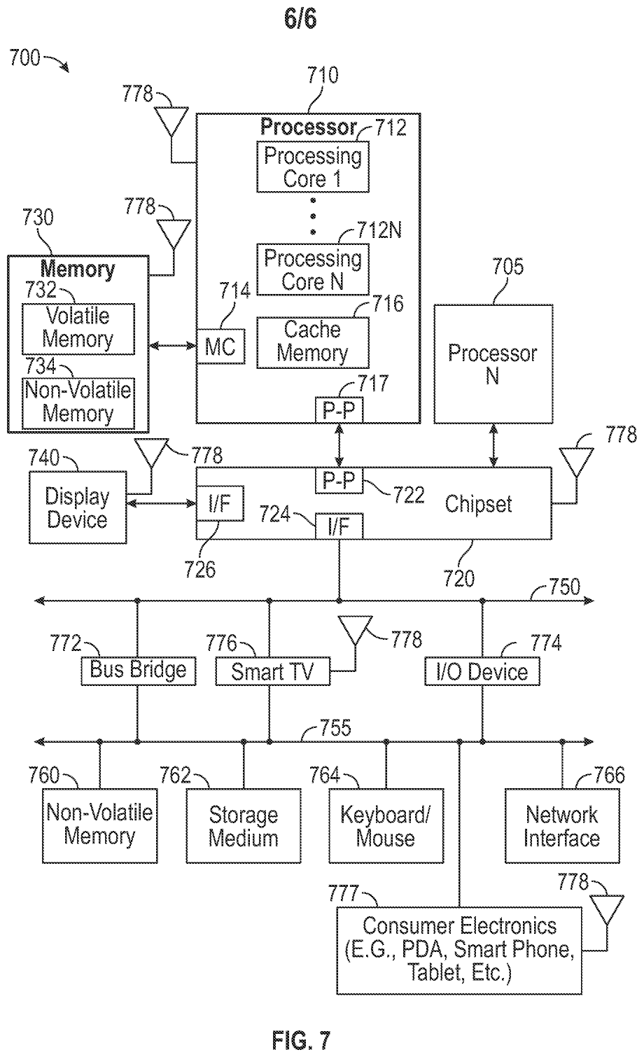

FIG. 7 illustrates a system level diagram, depicting an example of an electronic device (e.g., system) that can include, for example, a transmitter configured to selectively fan out a signal to one of multiple communication channels. FIG. 7 is included to show an example of a higher-level device application for the subject matter discussed above with regards to FIGS. 1-6. In one aspect, system 700 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance, or any other type of computing device. In some aspects, system 700 is a system on a chip (SOC) system.

In one aspect, processor 710 has one or more processor cores 712, . . . , 712N, where 712N represents the Nth processor core inside processor 710 where N is a positive integer. In one aspect, system 700 includes multiple processors including 710 and 705, where processor 705 has logic similar or identical to the logic of processor 710. In some aspects, processing core 712 includes, but is not limited to, pre-fetch logic to fetch instructions, decode logic to decode the instructions, execution logic to execute instructions and the like. In some aspects, processor 710 has a cache memory 716 to cache instructions and/or data for system 700. Cache memory 716 may be organized into a hierarchal structure including one or more levels of cache memory.

In some aspects, processor 710 includes a memory controller 714, which is operable to perform functions that enable the processor 710 to access and communicate with memory 730 that includes a volatile memory 732 and/or a non-volatile memory 734. In some aspects, processor 710 is coupled with memory 730 and chipset 720. Processor 710 may also be coupled to a wireless antenna 778 to communicate with any device configured to transmit and/or receive wireless signals. In one aspect, an interface for wireless antenna 778 operates in accordance with, but is not limited to, the IEEE 802.11 standard and its related family, Home Plug AV (HPAV), Ultra Wide Band (UWB), Bluetooth, WiMax, or any form of wireless communication protocol.

In some aspects, volatile memory 732 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 734 includes, but is not limited to, flash memory, phase change memory (PCM), read-only memory (ROM), electrically erasable programmable read-only memory (EEPROM), or any other type of non-volatile memory device.

Memory 730 stores information and instructions to be executed by processor 710. In one aspect, memory 730 may also store temporary variables or other intermediate information while processor 710 is executing instructions. In the illustrated aspect, chipset 720 connects with processor 710 via Point-to-Point (PtP or P-P) interfaces 717 and 722. Chipset 720 enables processor 710 to connect to other elements in system 700. In some aspects of the example system, interfaces 717 and 722 operate in accordance with a PtP communication protocol such as the Intel® QuickPath Interconnect (QPI) or the like. In other aspects, a different interconnect may be used.

In some aspects, chipset 720 is operable to communicate with processor 710, 705, display device 740, and other devices, including a bus bridge 772, a smart TV 776, I/O devices 774, nonvolatile memory 760, a storage medium (such as one or more mass storage devices) 762, a keyboard/mouse 764, a network interface 766, and various forms of consumer electronics 777 (such as a PDA, smart phone, tablet etc.), etc. In one aspect, chipset 720 couples with these devices through an interface 724. Chipset 720 may also be coupled to a wireless antenna 778 to communicate with any device configured to transmit and/or receive wireless signals.

Chipset 720 connects to display device 740 via interface 726. Display device 740 may be, for example, a liquid crystal display (LCD), a plasma display, cathode ray tube (CRT) display, or any other form of visual display device. In some aspects of the example system, processor 710 and chipset 720 are merged into a single SOC. In addition, chipset 720 connects to one or more buses 750 and 755 that interconnect various system elements, such as I/O devices 774, nonvolatile memory 760, storage medium 762, a keyboard/mouse 764, and network interface 766. Buses 750 and 755 may be interconnected together via a bus bridge 772.

In one aspect, storage medium 762 includes, but is not limited to, a solid-state drive, a hard disk drive, a universal serial bus flash memory drive, or any other form of computer data storage medium. In one aspect, network interface 766 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one aspect, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 7 are depicted as separate blocks within the system 700, the functions performed by some of these blocks may be integrated within a single semiconductor circuit or may be implemented using two or more separate integrated circuits. For example, although cache memory 716 is depicted as a separate block within processor 710, cache memory 716 (or selected aspects of 716) can be incorporated into processor core 712.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “an example aspect,” “some aspects,” “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a sensor device, an Internet of Things (IOT) device, a wearable device, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may, for example, be used in conjunction with devices and/or networks operating in accordance with existing IEEE 802.11 standards (including IEEE 802.11-2016 (IEEE 802.11-2016, IEEE Standard for Information technology—Telecommunications and information exchange between systems Local and metropolitan area networks—Specific requirements Part 11: Wireless LAN Medium Access Control (MAC) and Physical Layer (PHY) Specifications, Dec. 7, 2016); IEEE 802.11ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof, devices and/or networks operating in accordance with existing WiFi Alliance (WFA) Peer-to-Peer (P2P) specifications (including WiFi P2P technical specification, version 1.5, Aug. 4, 2015) and/or future versions and/or derivatives thereof, devices and/or networks operating in accordance with existing Wireless-Gigabit-Alliance (WGA) specifications (including Wireless Gigabit Alliance, Inc WiGig MAC and PHY Specification Version 1.1, April 2011, Final specification) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth, Global Positioning System (GPS), Wi-Fi, Wi-Max, ZigBeeTM, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting and/or the action of receiving. In one example, the phrase “communicating a signal” may refer to the action of transmitting the signal by a first device and may not necessarily include the action of receiving the signal by a second device. In another example, the phrase “communicating a signal” may refer to the action of receiving the signal by a first device and may not necessarily include the action of transmitting the signal by a second device.

Some demonstrative aspects may be used in conjunction with a wireless communication network communicating over a frequency band above 45 Gigahertz (GHz), e.g., 60 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a frequency band above 45 GHz, a frequency band below 20 GHz, e.g., a Sub 1 GHz (SIG) band, a 2.4 GHz band, a 5 GHz band, a WLAN frequency band, a WPAN frequency band, a frequency band according to the WGA specification, and the like.

As used herein, the term “circuitry” may, for example, refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, circuitry may include logic, at least partially operable in hardware. In some aspects, the circuitry may be implemented as part of and/or in the form of a radio virtual machine (RVM), for example, as part of a Radio processor (RP) configured to execute code to configured one or more operations and/or functionalities of one or more radio components.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna” or “antenna array,” as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

### ADDITIONAL NOTES AND ASPECTS

Example 1 is an apparatus comprising: memory to store source packets and coded packets; and processing circuitry configured to: in a first encoding phase, combine the source packets to generate a first set of coded packets, a coded packet being defined according to a degree, the degree being a count of the source packets used to generate the coded packet; in a second encoding phase, combine the source packets into a second set of coded packets, such that a total number of coded packets generated in the first encoding phase and in the second encoding phase is greater than a total number of source packets; and provide the first set of coded packets and the second set of coded packets in a transmission signal.

In Example 2, the subject matter of Example 1 can optionally include wherein the degree of at least one coded packet in the first set is different from the degree of at least one coded packet in the second set.

In Example 3, the subject matter of any of Examples 1-2 can optionally include wherein the degree of coded packets in the first set of coded packets is minimized.

In Example 4, the subject matter of any of Examples 1-3 can optionally include wherein the degree of coded packets in the second set of coded packets is maximized.

In Example 5, the subject matter of any of Examples 1-4 can optionally include wherein the degree of at least one coded packet is sampled from a probability distribution.

In Example 6, the subject matter of Example 5 can optionally include wherein the degree of coded packets in the first set of coded packets is sampled from a geometric distribution.

In Example 7, the subject matter of Example 5 can optionally include wherein the degree of coded packets in the second set of coded packets is sampled from a negative hypergeometric distribution.

Example 8 is a method for performing operations of any of Examples 1-7.

Example 9 is a system comprising means for performing any of Examples 1-7.

Example 10 is a software product comprising instructions to cause a processor to perform any of operations 1-7.

The above detailed description includes references to the accompanying drawings, which form a part of the detailed description. The drawings show, by way of illustration, specific aspects in which the invention can be practiced. These aspects are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description, with each claim standing on its own as a separate aspect, and it is contemplated that such aspects can be combined with each other in various combinations or permutations. The scope of the invention should be determined with reference to the appended claims, along with the full scope of equivalents to which such claims are legally entitled.

We claim:

1. An apparatus comprising:
memory to store source packets and coded packets; and
processing circuitry configured to:
in a first encoding phase, combine the source packets to generate a first set of coded packets, a coded packet being defined according to a degree, the degree being a count of the source packets used to generate the coded packet;
in a second encoding phase, combine the source packets into a second set of coded packets, such that a total number of coded packets generated in the first encoding phase and in the second encoding phase is greater than a total number of source packets; and
provide the first set of coded packets and the second set of coded packets in a transmission signal.

2. The apparatus of claim 1, wherein the degree of at least one coded packet in the first set is different from the degree of at least one coded packet in the second set.

3. The apparatus of claim 1, wherein the degree of coded packets in the first set of coded packets is minimized.

4. The apparatus of claim 1, wherein the degree of coded packets in the second set of coded packets is maximized.

5. The apparatus of claim 1, wherein the degree of at least one coded packet is sampled from a probability distribution.

6. The apparatus of claim 5, wherein the degree of coded packets in the first set of coded packets is sampled from a geometric distribution.

7. The apparatus of claim 5, wherein the degree of coded packets in the second set of coded packets is sampled from a negative hypergeometric distribution.

8. A non-transitory machine-readable medium including instructions that, when executed on processing circuitry, cause the processing circuitry to perform operations including:
in a first encoding phase, combining source packets to generate a first set of coded packets, a coded packet being defined according to a degree, the degree being a count of source packets used to generate the coded packet;
in a second encoding phase, combining the source packets into a second set of coded packets, such that a total number of coded packets generated in the first encoding phase and in the second encoding phase is greater than a total number of source packets; and
providing the first set of coded packets and the second set of coded packets in a transmission signal.

9. The non-transitory machine-readable medium of claim 8, wherein the degree of at least one coded packet in the first set is different from the degree of at least one coded packet in the second set.

10. The non-transitory machine-readable medium of claim 8, wherein the degree of coded packets in the first set of coded packets is minimized.

11. The non-transitory machine-readable medium of claim 8, wherein the degree of coded packets in the second set of coded packets is maximized.

12. The non-transitory machine-readable medium of claim 8, wherein the degree of at least one coded packet is sampled from a probability distribution.

13. The non-transitory machine-readable medium of claim 12, wherein the degree of coded packets in the first set of coded packets is sampled from a geometric distribution.

14. A computer system comprising:
transceiver circuitry to broadcast a data stream; and
processing circuitry coupled to the transceiver circuitry, the processing circuitry configured to:
receive a feedback beacon from one or more receivers of the broadcast; and
modify broadcast based on the feedback beacon by adapting a transmission repetition count or transmission power based on the feedback.

15. The computer system of claim 14, wherein the processing circuitry is configure to monitor a number of broadcast receivers based on the feedback beacon and to turn off broadcasting if the number falls to zero.

16. The computer system of claim 14, wherein the broadcast comprises a Bluetooth broadcast.

17. The computer system of claim 16, where the feedback beacon is received through at least one broadcast assistant paired to the broadcast receivers.

18. The computer system of claim 14, wherein the feedback beacon comprises a Bluetooth advertisement beacon.

19. The computer system of claim 14, wherein the feedback beacon and the broadcast share an encryption code.
